(19) United States
(12) Patent Application Publication
(10) Pub. No.: US 2025/0225997 A1
(43) Pub. Date: Jul. 10, 2025

(54) AUDIO PROCESSING

(71) Applicant: Nokia Technologies Oy, Espoo (FI)

(72) Inventors: Mohammad MALEKZADEH, Cambridge (GB); Yang LIU, Cambridge (GB); Khaldoon AL-NAIMI, Cambridge (GB)

(21) Appl. No.: 18/953,998

(22) Filed: Nov. 20, 2024

(30) Foreign Application Priority Data
Nov. 22, 2023 (GB) 2317849.4

(51) Int. Cl. G10L 21/0264; G10L 21/0216; G10L 25/30

(52) U.S. Cl. CPC G10L 21/0264; G10L 21/0216; G10L 25/30; G10L 2021/02166

(57) ABSTRACT

Example embodiments relate to audio processing. Some example embodiments may comprise a method, the method comprising receiving respective audio signals, A₁-A_{M}, captured by a plurality of microphones, M₁-M_{M}, having different locations on a mobile terminal, estimating motion of the mobile terminal and computing respective exposure parameters, η₁-η_{M}, for the respective audio signals, A₁-A_{M}. The method may also comprise generating respective spectrograms, S₁-S_{M}, for the respective audio signals, A₁-A_{M}, identifying a plurality of common time and frequency range segments across the respective spectrograms, S₁-S_{M} and computing dissimilarity values, δ₁-δ_{K}, for the common segments of the respective spectrograms, S₁-S_{M}, based on, for audio characteristics within a particular segment of a particular spectrogram, how similar those audio characteristics are to audio characteristics within the same particular segment of the other spectrograms. The method may also comprise based on the computed exposure parameters, η₁-η_{M}, and the computed dissimilarity values, δ₁-δ_{K}, selecting, for each particular common segment, which of the audio characteristics within that particular common segment are to be used to generate an audio output.

### RELATED APPLICATION

This application claims priority to United Kingdom Patent Application No. 2317849.4, filed Nov. 21, 2023, which is incorporated herein by reference in its entirety.

### FIELD

Example embodiments relate to processing of respective audio signals captured by a plurality of microphones having different locations on a mobile terminal.

### BACKGROUND

Some mobile terminals comprise a plurality of microphones having different locations on the mobile terminal. For example, a first microphone may be located on a rear surface of the mobile terminal, a second microphone may be located on a front surface of the mobile terminal and a third microphone may be located on an edge surface of the mobile terminal, between the rear and front surfaces. The microphones may respond to changes in air pressure caused by sound waves but may also respond to movement of the mobile terminal which causes a change in air pressure. Hence, audio signals captured by multiple microphones may comprise a mixture of wanted audio and unwanted noise due to the movement of the mobile terminal.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is described an apparatus, comprising: means for receiving respective audio signals, A₁-A_{M}, captured by a plurality of microphones, M₁-M_{M}, having different locations on a mobile terminal; means for estimating motion of the mobile terminal when capturing the respective audio signals, A₁-A_{M}; means for computing respective exposure parameters, η₁-η_{M}, for the respective audio signals, A₁-A_{M}, the exposure parameter for a particular audio signal being based on the estimated motion of the mobile terminal and the location of the microphone from which the particular audio signal is captured; means for generating respective spectrograms, S₁-S_{M}, for the respective audio signals, A₁-A_{M}; means for identifying a plurality of common time and frequency range segments across the respective spectrograms, S₁-S_{M}; means for computing dissimilarity values, δ₁-δ_{K}, for the common segments of the respective spectrograms, S₁-S_{M}, based on, for audio characteristics within a particular segment of a particular spectrogram, how similar those audio characteristics are to audio characteristics within the same particular segment of the other spectrograms; and means for, based on the computed exposure parameters, η₁-η_{M}, and the computed dissimilarity values, δ₁-δ_{K}, selecting, for each particular common segment, which of the audio characteristics within that particular common segment are to be used to generate an audio output.

In some example embodiments, the means for identifying the plurality of common segments may be configured to: determine an ordered list of the respective spectrograms, S₁-S_{M}, based on the respective exposure parameters, η₁-η_{M}, computed for the respective audio signals, A₁-A_{M}, from which the respective spectrograms are generated; segment the first and second spectrograms in the ordered list to identify respective first and second sets of segments; and combine the respective first and second sets of segments to identify a first plurality of common segments.

In some example embodiments, the means for computing the dissimilarity values, δ₁-δ_{L}, may be configured, responsive to identifying the first plurality of common segments: to compute the dissimilarity values, δ₁-δ_{K}, for the first plurality of common segments of the first and second spectrograms.

In some example embodiments, the means for identifying the plurality of common segments may be further configured to: for a next spectrogram in the ordered list: segment the next spectrogram to identify a further set of segments; and combine the further set of segments with the first plurality of common segments to identify an updated plurality of common segments.

In some example embodiments, the means for computing the dissimilarity values, δ₁-δ_{K}, may be configured, responsive to identifying the updated plurality of common segments: to compute the dissimilarity values, δ₁-δ_{K}, for the updated plurality of common segments of the first, second and next spectrograms.

In some example embodiments, the respective exposure parameters, η₁-η_{M}, may be indicative of the exposure to airflow of the respective microphones, M₁-M_{M}, from which the respective audio signals, A₁-A_{M}, are captured due to the motion of the user terminal, and the ordered list is in the order of the most exposed microphone to the least exposed microphone.

In some example embodiments, the means for selecting comprises a learned model may be configured: to receive as a set of input data: the computed exposure parameters, η_{1-M}, for the respective audio signals, A₁-A_{M}, the respective spectrograms, S₁-S_{M}, and the computed dissimilarity values, δ₁-δ_{K}, for the common segments of the respective spectrograms; to select, for each common segment, and based on the set of input data, which audio characteristics in that common segment of the respective spectrograms are to be used to generate the audio output; and to provide as output data the selected audio characteristics for the common segments.

In some example embodiments, the learned model may be trained by: providing ground truth data corresponding to respective audio signals, A₁-A_{M}, received by the plurality of microphones, M₁-M_{M}, when a same type of mobile terminal is stationary; computing reference exposure parameters, η₁-η_{M}, and dissimilarity values, δ₁-δ_{L} for common segments of respective spectrograms generated when said same type of mobile terminal is in motion; using an initial model to provide output data representing selected audio characteristics for each common segment based on the reference exposure parameters, η₁-η_{M}, and dissimilarity values, δ_{1-K}; comparing the output data with the ground truth data to determine error data; and updating the initial model based on the error data.

In some example embodiments, the selected audio characteristics for each common segment may be provided in an output spectrogram, S*, and the apparatus may further comprise means for converting the output spectrogram, S*, to an audio output.

In some example embodiments, the means for estimating motion of the mobile terminal may be configured to receive one or more motion parameters indicative of at least a direction of motion of the mobile terminal, and the exposure parameter, η₁-η_{M}, for the particular audio signal, A₁-A_{M}, may be computed based on the location of the microphone, M₁-M_{M}, from which the particular audio signal is captured in relation to the direction of the motion.

In some example embodiments, the means for estimating motion of the mobile terminal may be configured to receive further motion parameters indicative of a velocity of the motion and an orientation of the mobile terminal, and the exposure parameter, η₁-η_{M}, for the particular audio signal, A₁-A_{M}, may be computed further based on the velocity of the motion and the orientation of the mobile terminal.

In some example embodiments, the one or more motion parameters may be received from an inertial measurement unit, IMU, of the mobile terminal.

In some example embodiments, the respective audio signals, A₁-A_{M} may be captured within a particular time window; the respective exposure parameters, η₁-η_{M}, and dissimilarity values, δ₁-δ_{L}, for the common segments of the respective spectrograms, S₁-S_{M}, may be updated a plurality of times within the particular time window; and the computed audio output may be updated within the particular time window based on the updated respective exposure parameters, η₁-η_{M}, and dissimilarity values, δ₁-δ_{K}.

According to a second aspect, there is described a method, comprising: receiving respective audio signals, A₁-A_{M}, captured by a plurality of microphones, M₁-M_{M}, having different locations on a mobile terminal; estimating motion of the mobile terminal when capturing the respective audio signals, A₁-A_{M}; computing respective exposure parameters, η₁-η_{M}, for the respective audio signals, A₁-A_{M}, the exposure parameter for a particular audio signal being based on the estimated motion of the mobile terminal and the location of the microphone from which the particular audio signal is captured; generating respective spectrograms, S₁-S_{M}, for the respective audio signals, A₁-A_{M}; identifying a plurality of common time and frequency range segments across the respective spectrograms, S₁-S_{M}; computing dissimilarity values, δ₁-δ_{K}, for the common segments of the respective spectrograms, S₁-S_{M}, based on, for audio characteristics within a particular segment of a particular spectrogram, how similar those audio characteristics are to audio characteristics within the same particular segment of the other spectrograms; and based on the computed exposure parameters, η₁-η_{M}, and the computed dissimilarity values, δ₁-δ_{L}, selecting, for each particular common segment, which of the audio characteristics within that particular common segment are to be used to generate an audio output.

In some example embodiments, identifying the plurality of common segments may comprise: determining an ordered list of the respective spectrograms, S₁-S_{M}, based on the respective exposure parameters, η₁-η_{M}, computed for the respective audio signals, A₁-A_{M}, from which the respective spectrograms are generated; segmenting the first and second spectrograms in the ordered list to identify respective first and second sets of segments; and combining the respective first and second sets of segments to identify a first plurality of common segments.

In some example embodiments, computing the dissimilarity values, δ₁-δ_{K}, may comprise, responsive to identifying the first plurality of common segments: computing the dissimilarity values, δ₁-δ_{K}, for the first plurality of common segments of the first and second spectrograms.

In some example embodiments, identifying the plurality of common segments may further comprise: for a next spectrogram in the ordered list: segmenting the next spectrogram to identify a further set of segments; and combining the further set of segments with the first plurality of common segments to identify an updated plurality of common segments.

In some example embodiments, computing the dissimilarity values, δ₁-δ_{L}, may comprise, responsive to identifying the updated plurality of common segments: computing the dissimilarity values, δ₁-δ_{L}, for the updated plurality of common segments of the first, second and next spectrograms.

In some example embodiments, the respective exposure parameters, η₁-η_{M}, may be indicative of the exposure to airflow of the respective microphones, M₁-M_{M}, from which the respective audio signals, A₁-A_{M}, are captured due to the motion of the user terminal, and the ordered list may be in the order of the most exposed microphone to the least exposed microphone.

In some example embodiments, the selecting may comprise use of a learned model for: receiving as a set of input data: the computed exposure parameters, η_{1-M}, for the respective audio signals, A₁-A_{M}, the respective spectrograms, S₁-S_{M}, and the computed dissimilarity values, δ₁-δ_{L}, for the common segments of the respective spectrograms; selecting, for each common segment, and based on the set of input data, which audio characteristics in that common segment of the respective spectrograms are to be used to generate the audio output; and providing as output data the selected audio characteristics for the common segments.

In some example embodiments, the learned model may be trained by: providing ground truth data corresponding to respective audio signals, A₁-A_{M}, received by the plurality of microphones, M₁-M_{M}, when a same type of mobile terminal is stationary; computing reference exposure parameters, η₁-η_{M}, and dissimilarity values, δ₁-δ_{M} for common segments of respective spectrograms generated when said same type of mobile terminal is in motion; using an initial model to provide output data representing selected audio characteristics for each common segment based on the reference exposure parameters, η₁-η_{M}, and dissimilarity values, δ_{1-K}; comparing the output data with the ground truth data to determine error data; and updating the initial model based on the error data.

In some example embodiments, the selected audio characteristics for each common segment may be provided in an output spectrogram, S″, and the method may further comprise converting the output spectrogram, S*, to an audio output.

In some example embodiments, estimating motion of the mobile terminal may comprise receiving one or more motion parameters indicative of at least a direction of motion of the mobile terminal, and the exposure parameter, η₁-η_{M}, for the particular audio signal, A₁-A_{M}, may be computed based on the location of the microphone, M₁-My, from which the particular audio signal is captured in relation to the direction of the motion.

In some example embodiments, estimating motion of the mobile terminal may comprise receiving further motion parameters indicative of a velocity of the motion and an orientation of the mobile terminal, and the exposure parameter, η₁-ηu, for the particular audio signal, A₁-A_{M}, may be computed further based on the velocity of the motion and the orientation of the mobile terminal.

In some example embodiments, the one or more motion parameters may be received from an inertial measurement unit, IMU, of the mobile terminal.

In some example embodiments, the respective audio signals, A₁-A_{M} may be captured within a particular time window; the respective exposure parameters, η₁-η_{M}, and dissimilarity values, δ₁-δ_{K}, for the common segments of the respective spectrograms, S₁-S_{M}, may be updated a plurality of times within the particular time window; and the computed audio output may be updated within the particular time window based on the updated respective exposure parameters, η₁-η_{M}, and dissimilarity values, δ₁-δ_{K}.

According to a third aspect, there is described a computer program product, comprising a set of instructions which, when executed on an apparatus, is configured to: cause the apparatus to carry out a method, comprising: receiving respective audio signals, A₁-A_{M}, captured by a plurality of microphones, M₁-M_{M}, having different locations on a mobile terminal; estimating motion of the mobile terminal when capturing the respective audio signals, A₁-Ax; computing respective exposure parameters, η₁-η_{M}, for the respective audio signals, A₁-A_{M}, the exposure parameter for a particular audio signal being based on the estimated motion of the mobile terminal and the location of the microphone from which the particular audio signal is captured; generating respective spectrograms, S₁-Su, for the respective audio signals, A₁-A_{M}; identifying a plurality of common time and frequency range segments across the respective spectrograms, S₁-S_{M}; computing dissimilarity values, δ₁-δ_{L}, for the common segments of the respective spectrograms, S₁-S_{M}, based on, for audio characteristics within a particular segment of a particular spectrogram, how similar those audio characteristics are to audio characteristics within the same particular segment of the other spectrograms; and based on the computed exposure parameters, η₁-η_{M}, and the computed dissimilarity values, δ₁-δ_{L}, selecting, for each particular common segment, which of the audio characteristics within that particular common segment are to be used to generate an audio output.

The third aspect may include any other feature mentioned with respect to the method of the second aspect.

According to a fourth aspect, there is described a non-transitory computer readable medium comprising program instructions stored thereon to cause the apparatus to carry out a method, comprising: receiving respective audio signals, A₁-A_{M}, captured by a plurality of microphones, M₁-M_{M}, having different locations on a mobile terminal; estimating motion of the mobile terminal when capturing the respective audio signals, A₁-A_{M}; computing respective exposure parameters, η₁-η_{M}, for the respective audio signals, A₁-A_{M}, the exposure parameter for a particular audio signal being based on the estimated motion of the mobile terminal and the location of the microphone from which the particular audio signal is captured; generating respective spectrograms, S₁-Su, for the respective audio signals, A₁-Av; identifying a plurality of common time and frequency range segments across the respective spectrograms, S₁-S_{M}; computing dissimilarity values, δ₁-δ_{L}, for the common segments of the respective spectrograms, S₁-Sx, based on, for audio characteristics within a particular segment of a particular spectrogram, how similar those audio characteristics are to audio characteristics within the same particular segment of the other spectrograms; and based on the computed exposure parameters, η₁-η_{M}, and the computed dissimilarity values, δ₁-δ_{L}, selecting, for each particular common segment, which of the audio characteristics within that particular common segment are to be used to generate an audio output.

The fourth aspect may include any other feature mentioned with respect to the method of the second aspect.

According to a fifth aspect, there is described an apparatus comprising at least one processing core, at least one memory including computer program code, the at least one memory and the computer program code being configured to, with the at least one processing core, cause the apparatus to: receive respective audio signals, A₁-A_{M}, captured by a plurality of microphones, M₁-M_{M}, having different locations on a mobile terminal; estimate motion of the mobile terminal when capturing the respective audio signals, A₁-A_{M}; compute respective exposure parameters, η₁-η_{M}, for the respective audio signals, A₁-A_{M}, the exposure parameter for a particular audio signal being based on the estimated motion of the mobile terminal and the location of the microphone from which the particular audio signal is captured; generate respective spectrograms, S₁-S_{M}, for the respective audio signals, A₁-A_{M}; identify a plurality of common time and frequency range segments across the respective spectrograms, S₁-S_{M}; compute dissimilarity values, δ₁-δ_{L}, for the common segments of the respective spectrograms, S₁-S_{M}, based on, for audio characteristics within a particular segment of a particular spectrogram, how similar those audio characteristics are to audio characteristics within the same particular segment of the other spectrograms; and based on the computed exposure parameters, η₁-η_{M}, and the computed dissimilarity values, δ₁-δ_{L}, select, for each particular common segment, which of the audio characteristics within that particular common segment are to be used to generate an audio output.

The fifth aspect may include any other feature mentioned with respect to the method of the second aspect.

### DRAWINGS

Example embodiments will be described, by way of non-limiting example, with reference to the accompanying drawings, in which:

FIG. 1 is a front plan view of a mobile terminal;

FIG. 2 is a perspective view of the mobile terminal;

FIG. 3 is a graphical view of a segmented spectrogram;

FIG. 4 is a graphical view of a plurality of audio signals that may be captured by the mobile terminal;

FIG. 5, including FIGS. 5A and 5B, is a graphical view of a plurality of motion parameters that may be generated by the mobile terminal;

FIG. 6 is a flow diagram showing operations according to some example embodiments;

FIG. 7 is a block diagram of functional modules that may implement the FIG. 6 operations;

FIG. 8 shows the FIG. 1 mobile terminal in motion;

FIG. 9 shows first, second a third spectrograms and segmentation according to some example embodiments;

FIG. 10 shows, in graphical form, how the first, second and third spectrograms may be combined to identify a set of common segments according to some example embodiments;

FIG. 11 shows, in graphical form, how an output spectrogram may be generated using selected audio characteristics according to some example embodiments;

FIG. 12 is a schematic view of an apparatus that may be configured to implement the FIG. 6 operations; and

FIG. 13 is a plan view of a non-transitory medium which may store computer-readable instructions for implementing the FIG. 6 operations.

### DETAILED DESCRIPTION

Example embodiments relate to processing of respective audio signals captured by a plurality of microphones having different locations on a mobile terminal.

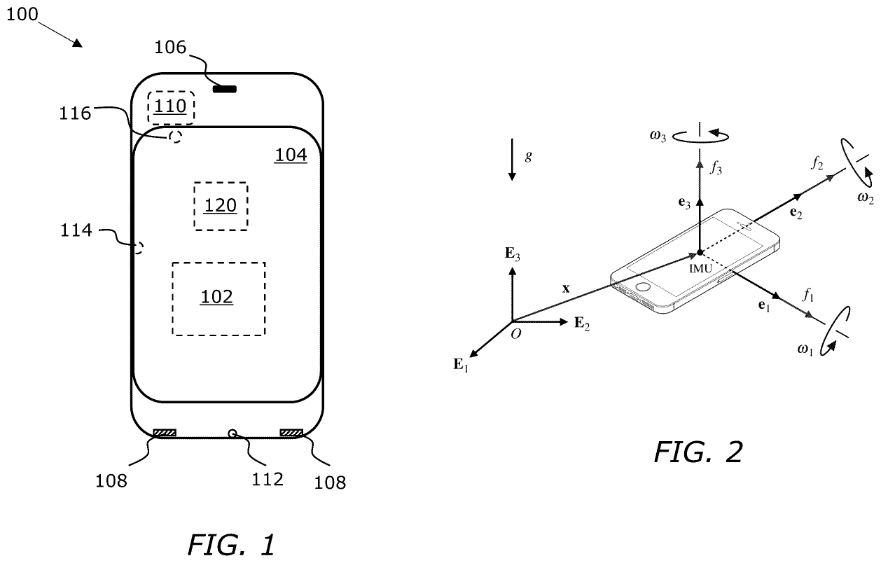

FIG. 1 is a front plan view of a mobile terminal 100 which may be used in one or more example embodiments. The mobile terminal 100 may be, but is not limited to, a smartphone, tablet computer, digital assistant, laptop or wearable device. Examples of wearable devices include earphones, earbuds and extended reality (XR) headsets.

The mobile terminal 100 may comprise one or more processors 102, one or more memories (not shown), a display screen 104, one or more loudspeakers 106, 108, one or more cameras 110 and a plurality of microphones 112, 114, 116. The one or more memories may store software, comprising computer-readable instructions which, when executed by the one or more processors, may perform one or more operations according to one or more example embodiments.

In the FIG. 1 example, a first microphone 112 is on the front lower side of the mobile terminal 100, a second microphone 114 is on a rear side edge of the mobile terminal, and the third microphone 116 is on a rear side of the mobile terminal, approximately mid-way between upper and lower edges of the mobile terminal 100.

In some example embodiments, there may be two or more than three microphones, each of which has a respective known location on the mobile terminal 100.

The first, second and third microphones 112, 114, 116 may comprise microelectron-mechanical system (MEMS) microphones.

The mobile terminal 100 may also comprise a means for estimating its own motion during use.

For example, the mobile terminal 100 may comprise one or more inertial measurement units (IMU) 120. As will be known, the IMU 120 may comprise one or more of an accelerometer, gyroscope and magnetometer for measuring, respectively, linear acceleration, rotational rate and a heading reference as indicated in FIG. 2.

In some embodiments, there may be provided one or more IMU 120 for measuring linear acceleration, rotational rate and a heading reference for each principal axis, being pitch, roll and yaw, as also indicated in FIG. 2. The one or more IMUs 120 in this case may therefore be termed a 9-axis motion sensor.

Each of the accelerometer, gyroscope and magnetometer may generate motion data or motion parameters which individually, or usually collectively, may be processed using known software to generate a geometrical model of the mobile terminal's position in terms of direction, velocity and orientation. Taken over time, the software may therefore generate a geometrical model of the mobile terminal's movement in space.

In use, the mobile terminal 100 may be enabled to capture sound waves, such as, but not limited to, speech or even physiological parameters, e.g., heart rate, over a period of time.

The sound waves cause a change in air pressure which may be captured by the first, second and third microphones 112, 114, 116 at their respective locations. However, movement of the mobile terminal 100 will also cause a change in air pressure that may be captured by one or more of the first, second and third microphones 112, 114, 116. The wanted sounds, e.g., the speech or heart rate, may be termed a main characteristic and the unwanted “noise” due to motion of the mobile terminal 100 may be termed a motion characteristic.

The presence of main and motion characteristics may distort the captured audio in an undesirable way. For example, it may be desirable to use the main characteristic in one or more subsequent processing operations, which operations may not work correctly due to the presence of the captured motion characteristic(s) which is or are unpredictable. Example subsequent processing operations may comprise voice recognition operations and/or machine learning (ML) training and/or inference operations.

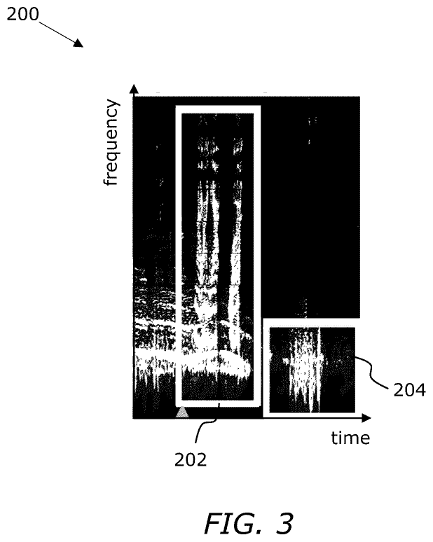

FIG. 3 shows a spectrogram 200, which is a visual or graphical way of representing audio signals in terms of time and frequency characteristics. In FIG. 3, the horizontal axis indicates time, and the vertical axis represents frequency. When depicted in colour, the spectrogram 200 may represent amplitude or intensity such that different colours indicate different amplitudes or intensities.

The spectrogram 200 in the FIG. 3 example comprises first and second segments 202, 204. The first segment 202 encloses a captured main characteristic, e.g., speech, and the second segment 204 encloses a captured motion characteristic.

Often, the main and motion characteristics in a spectrogram are not so distinct and may blend together.

A segment, as used herein, is sub-portion of a spectrogram. A segmented spectrogram may comprise two or more segments. Enclosed within a particular segment are a sub-set of time and frequency characteristics of captured audio, i.e., audio characteristics. Spectrograms may be segmented using one of a plurality of different algorithms. A segment may be configured to have any suitable shape, e.g., a square, a rectangle, a polygon, or a circle and may have any suitable size.

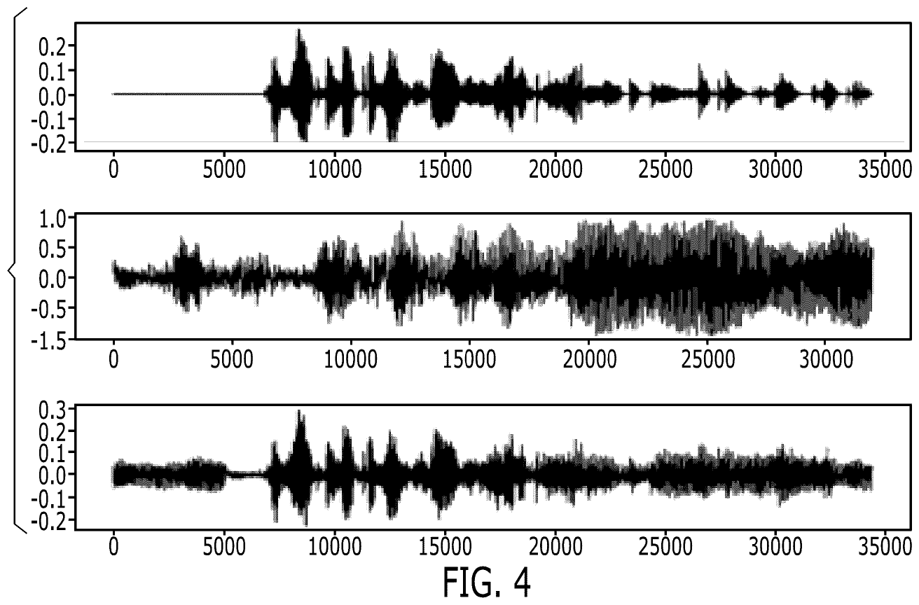

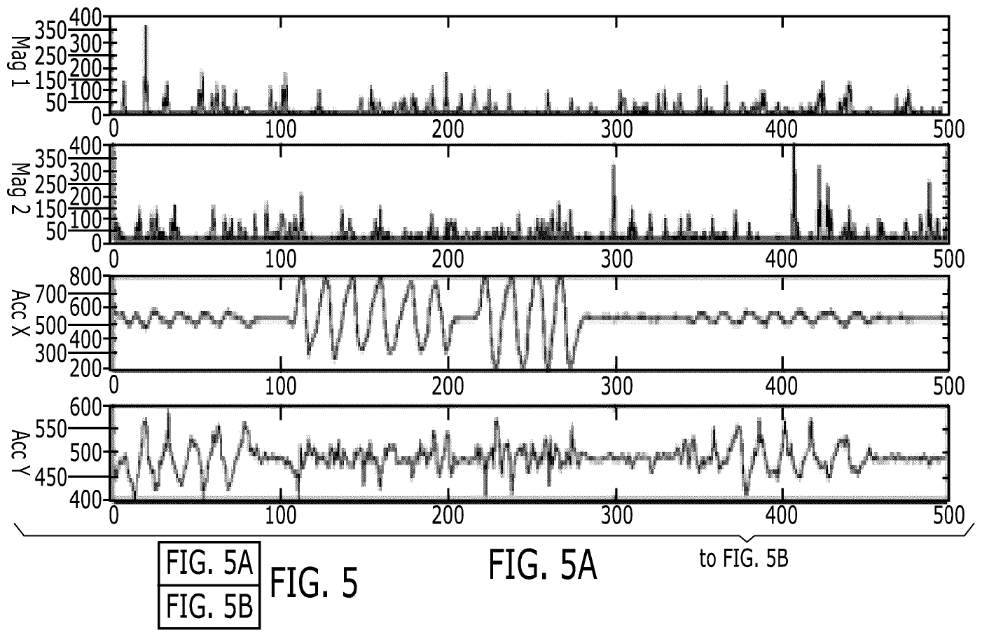

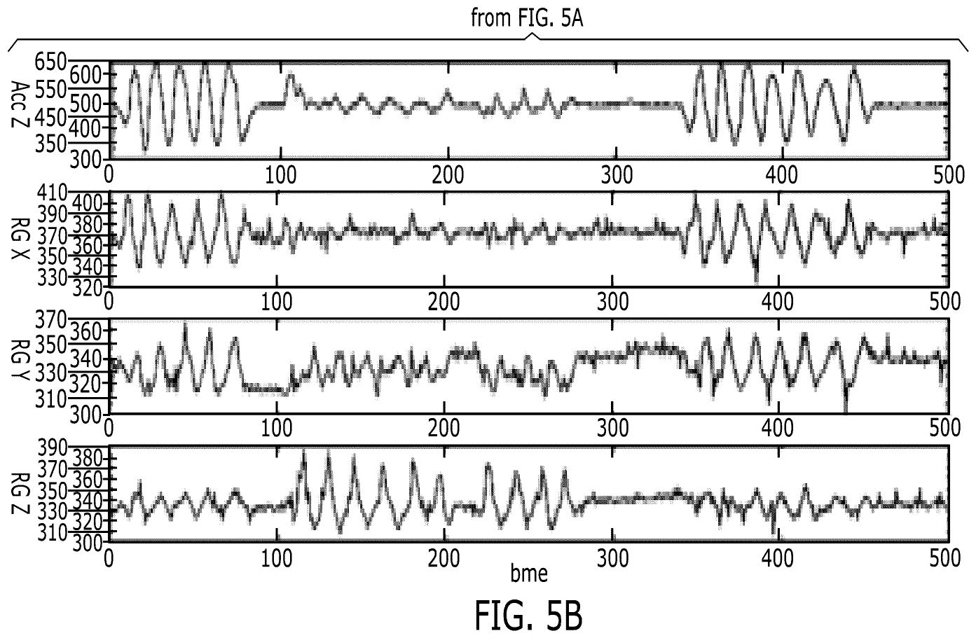

For completeness, FIG. 4 shows respective first, second and third audio signals captured by the first, second and third microphones 112, 114, 116 in FIG. 1. FIG. 5, including FIGS. 5A and 5B, represents motion data generated by the IMU 120 for a particular movement of the mobile terminal 100 during capture.

For example, the respective audio signals may comprise a 44100 Hz sampling rate, which is about fifty times greater than motion data generated by the IMU 120, assuming the use of a 9-axis IMU 120, running at 100 Hz and therefore producing 900 values per second. The frequency spectrum of the first, second and third microphones 112, 114, 116 may therefore be five hundred times larger than that of the IMU 120, making direct comparison between audio signals and the motion data difficult and/or non-meaningful. For example, it cannot be reliably stated that that if a 50 Hz component is observed in motion data from the IMU 120 when capturing audio signals by the first, second and third microphones 112, 114, 115, then 50 Hz frequencies in the respective audio signals can be filtered out to remove noise due to movement of the user terminal 100. There is no correct and straightforward rule because user terminal movements may cause complex, non-linear effects due to air pressure changes around the first, second and third microphones 112, 114, 116.

Example embodiments may relate to processing of respective audio signals captured by a plurality of microphones of a mobile terminal, which processing takes into account the respective locations of the plurality of microphones. Example embodiments may process respective spectrograms representing the respective audio signals such as to mitigate noise effects due to movement.

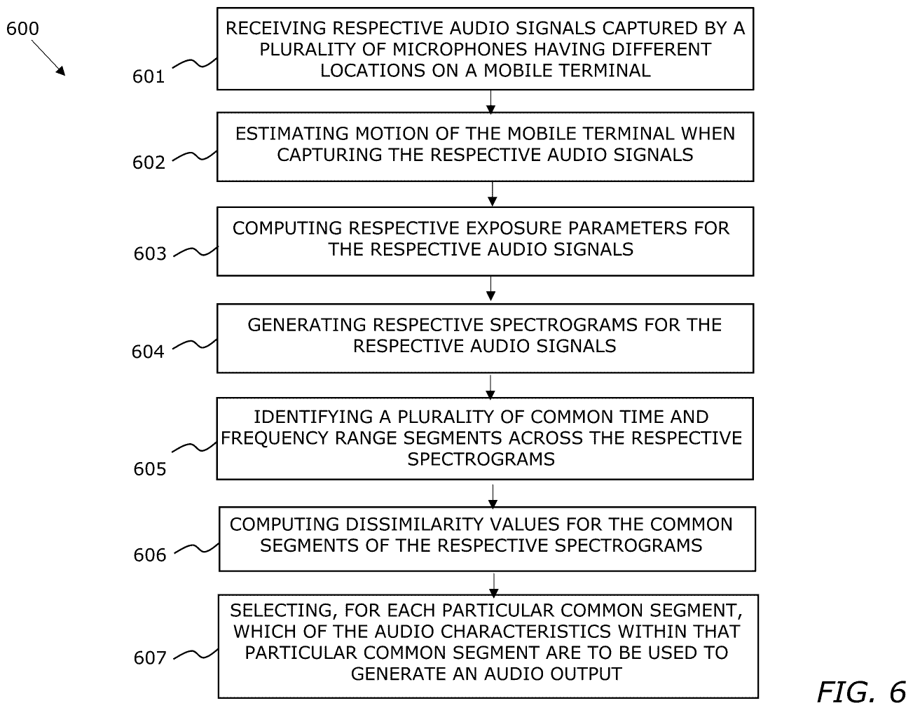

FIG. 6 is a flow diagram indicating operations 600 according to one or more other example embodiments. The operations 600 relate to those that may be performed by a processing device, for example by the mobile terminal 100 of FIG. 1 or possibly a separate device in communication with the mobile terminal. The operations may be performed in hardware, software, firmware or a combination thereof. For example, the operations may be performed individually, or collectively, by a means, wherein the means may comprise at least one processor and at least one memory storing instructions that, when executed by the at least one processor, cause the performance of the operations.

A first operation 601 may comprise receiving respective audio signals, A_{1-M}, captured by a plurality of microphones, M_{1-M}, having different locations on a mobile terminal.

A second operation 602 may comprise estimating motion of the mobile terminal when capturing the respective audio signals, A_{1-M}.

A third operation 603 may comprise for computing respective exposure parameters, η_{1-M}, for the respective audio signals, A_{1-M}. The exposure parameter n for a particular audio signal A may be based on the estimated motion of the mobile terminal and the location of the microphone from which the particular audio signal is captured.

A fourth operation 604 may comprise generating respective spectrograms, S_{1-M}, for the respective audio signals, A_{1-M}.

A fifth operation 605 may comprise identifying a plurality of common time and frequency range segments across the respective spectrograms, S_{1-M}.

A sixth operation 606 may comprise computing dissimilarity values, δ_{1-K}, for the common segments of the respective spectrograms, S_{1-M}. The dissimilarity values, δ_{1-K}, may be based on, for audio characteristics within a particular common segment of a particular spectrogram, how similar those audio characteristics are to audio characteristics within the same particular common segment of the other spectrograms.

A seventh operation 607 may comprise selecting, for each common segment, which of the audio characteristics within that common segment are to be used to generate an audio output. The selecting may be based on the computed exposure parameters, η_{1-M}, and the computed dissimilarity values, δ_{1-K}.

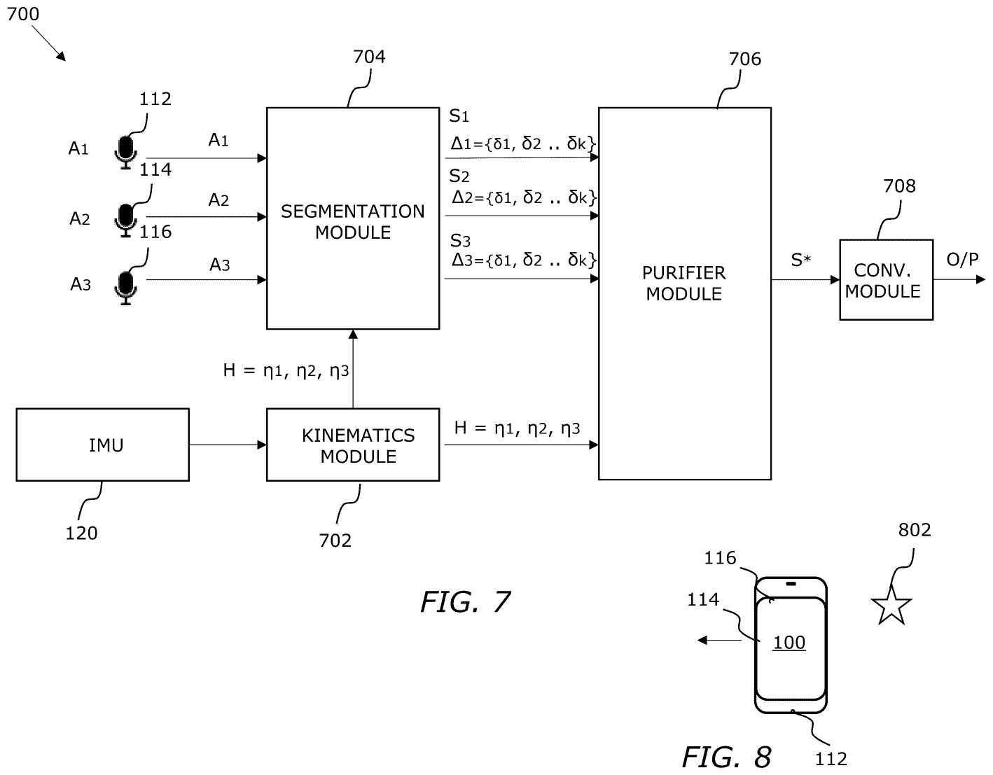

FIG. 7 is a schematic block diagram of an example system 700 for performing the FIG. 6 operations 600. The example system 700 may be partially or entirely comprised in the mobile terminal 100 of FIG. 1.

The system 700 may comprise the first, second and third microphones 112, 114, 116 having their known respective locations on the mobile terminal 100. The system 700 may also comprise the one or more IMUs 120. The system 700 may also comprise a kinematics module 702, a segmentation module 704, a purifier module 706 and a conversion module 708. Although shown as separate modules, at least some of the modules may be combined into one module.

According to the first operation 601, respective first, second and third audio signals A₁-A₃ captured by the first, second and third microphones 112, 114, 116 may be provided to the segmentation module 704. The respective first, second and third audio signals A₁-A₃ may correspond to a particular time window.

According to the second operation 602, the IMU 120 may provide motion parameters to the kinematics module 702.

The kinematics module 702 may be configured, based on the motion parameters mentioned above, to determine or model one or more movements of the mobile terminal 100, and to compute respective exposure parameters η₁-η₃ during said particular time window.

The respective exposure parameters η₁-η₃ may reflect (by any suitable method) the degree to which each of the first, second and third microphones 112, 114, 116 are exposed to the one or more movements of the mobile terminal 100 and therefore the relative impact of the movements on the respective first, second and third audio signals A₁-A₃. For example, the value of n may be a value between [0, 1] where 0 represents no exposure and 1 represents maximum exposure.

For the sake of simplicity, and with reference to FIG. 8, it may be assumed that the mobile terminal 100 is moved leftwards during capture of a sound source 802.

It may be assumed that the first and third microphones 112, 116 are less exposed to the movement due to their respective locations. The second microphone 114 is the most exposed due to its location on the left-hand side of the user terminal 100. The following example values for n may therefore be computed:
η₁: 0.3
η₂: 0.9
η₃: 0.2.

The respective exposure parameters η₁-η₃ may be provided to the segmentation module 704 and, in some embodiments, to the purifier module 706.

In accordance with the fourth operation 604, the segmentation module 704 may be configured to generate respective first, second and third spectrograms, S₁-S₃, for the first, second and third audio signals, A₁-A₃.

Known methods for generating the spectrograms, S₁-S₃, include dividing the audio signal, A, into equal length time segments, windowing each time segment and computing its spectrum to obtain the short-time Fourier transform.

In accordance with the fifth operation 605, the segmentation module 704 may also be configured to identify a plurality of common segments across the respective first, second and third spectrograms, S₁-S₃.

Common segments comprise segments which enclose the same portion of time and frequency space across the respective first, second and third spectrograms, S₁-S₃. The common segments may collectively enclose all, or substantially all, portions of time and frequency space such as to leave little or no gaps.

Identifying the plurality of common segments may be performed in a number of different ways.

Example embodiments may take into account the respective exposure parameters η₁-η₃.

More specifically, the respective exposure parameters η₁-η₃ may be used to provide an ordered list of the audio signals A₁-A₃ or of their respective spectrograms, S₁-S₃.

The ordered list may be in the order of most exposed microphone to the least exposed microphone, effectively defining a rank order. The respective spectrograms, S₁-S₃, may be processed in pairs using the rank order, and common segments may be iteratively identified and updated between pairs of spectrograms to identify the common segments.

Based on the above example values for n, the second and first spectrograms, S₁-S₃, may be processed first. The third spectrogram, S₃, may be processed last.

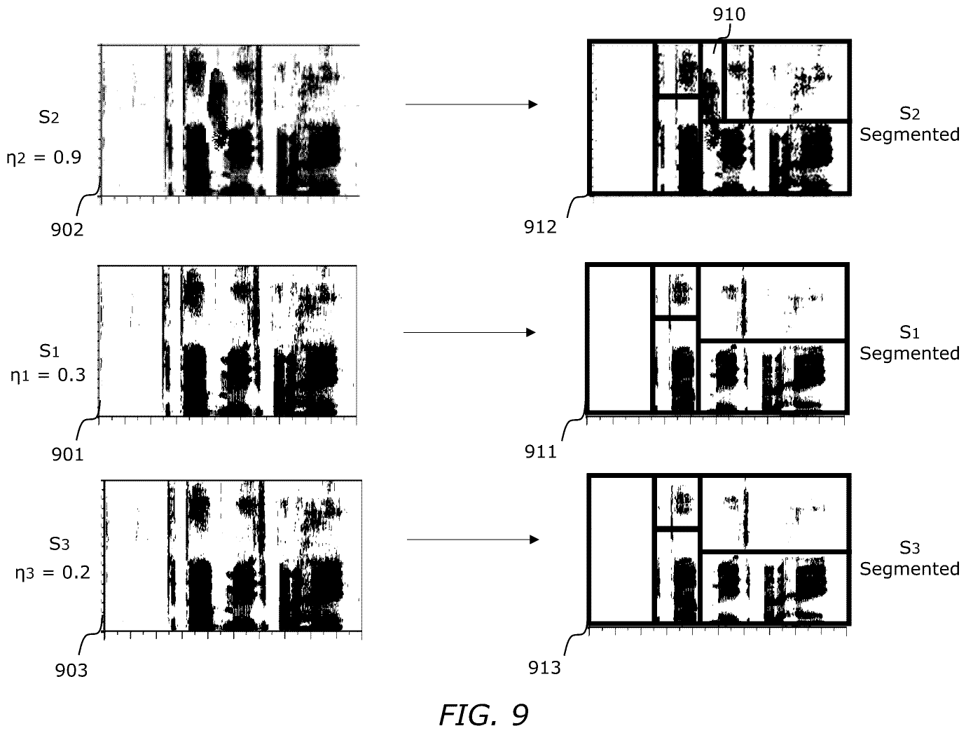

FIG. 9 shows a part of the segmentation process according to some example embodiments.

Respective first, second and third spectrograms, S₁-S₃, indicated by reference numerals 901, 902, 903, are shown in the above rank order.

The second and first spectrograms 902, 901 may be individually segmented to identify, within each said spectrogram, a plurality of segments, for example based on similarity of audio characteristics within different parts of the particular spectrogram. Segmentation may comprise edge-based segmentation (e.g. by identifying boundaries in the spectrogram via identifying rapid changes in magnitude of time and frequency characteristics or points) or region-based (e.g. starting with seed locations and growing regions by adding neighbouring time and frequency points that have same or similar magnitudes) or other forms of segmentation.

The second spectrogram 902 is first segmented such as to identify a set of segments 912 (second set of segments); the second set of segments comprises six segments. The first spectrogram 901 is segmented such as to identify a set of segments 911 (first set of segments); the first set of segments comprises five segments.

The second set of segments 912 includes an additional segment 910 compared to the first set of segments 911 which reflects, in this relatively simple example, some captured motion characteristics.

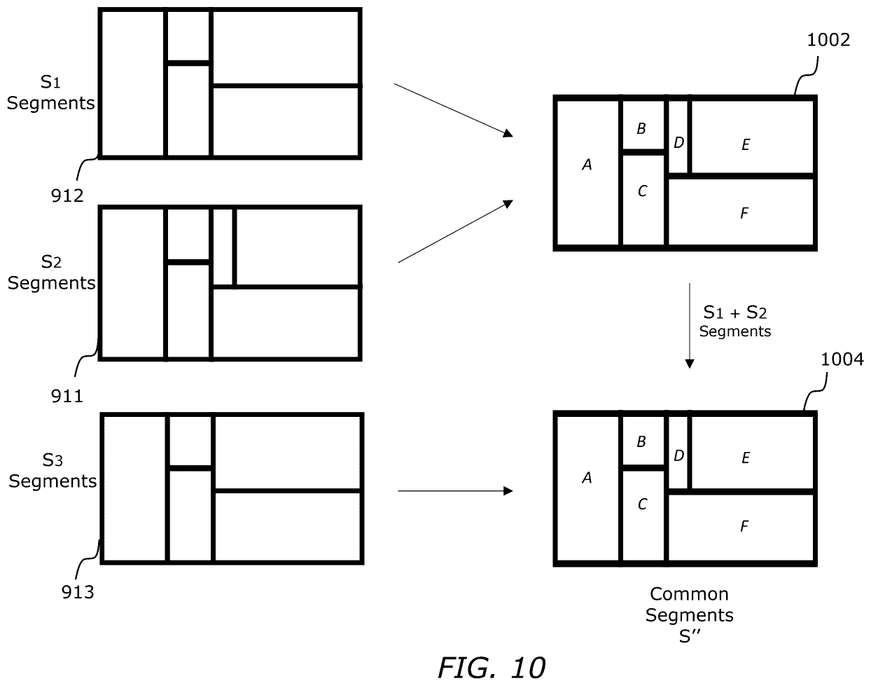

Referring now to FIG. 10, the second and first sets of segments 912, 913 may be combined (overlaid) to identify a first set of common segments 1002, labelled A-F.

Referring back to FIG. 9, the third spectrogram 903, associated with the least exposed audio signal, A₃, is segmented such as to identify a set of segments 913 (third set of segments); the third set of segments comprises five segments that happen to be near identical to the first set of segments 911.

Referring again to FIG. 10, the third set of segments 913 may be combined (overlaid) with the first set of common segments 1002 set to identify an updated, second set of common segments 1004. In this case, no new common segments are identified, but, in other cases where the third set of segments 913 differ even only slightly from the first and/or second set of segments 911, 912, one or more new segments would be identified in this step.

This above segmentation process may be repeated in turn for further spectrograms S, if any.

In the present example, there are no further spectrograms and hence the second set of common segments 1004 is used for subsequent processing.

In accordance with the sixth operation 606, dissimilarity values, &A-8F, for each of the first, second and third spectrograms 901, 902, 903 may be computed for each of the common segments A-F.

Effectively, the second set of common segments 1004 is overlaid over the each of the first, second and third spectrograms 901, 902, 903 and the audio characteristics in a particular common segment of one spectrogram are compared with the audio characteristics of the other two spectrograms for the same common segment. Determining a similarity/dissimilarity between the common segments of different spectrograms may involve using a correlation function (e.g. cross-correlation or similar) to measure temporal similarity. Alternatively, cosine similarity may be used to compute how similar the values of two segments are, if considered as vectors. Alternatively, dynamic time warping may be used, considering that segments include an element of time. Euclidian distance methods may also be used. The choice of metric used may depend on the application requirements.

The dissimilarity value δ represents how similar/dissimilar the audio characteristics are to audio characteristics in the same common segment of all other spectrograms.

We may, for example, compare audio characteristics of common segment A of the second spectrogram 902 against audio characteristics of segment A of (i) the first spectrogram 901, and then against (ii) the third spectrogram 903, and average the results to provide the value of δ for common segment A of the second spectrogram.

The sixth operation 606 may therefore produce for each spectrogram 901, 902, 902 a set of dissimilarity values, Δ=δ_{A}-δ_{F}.

For example, the value of δ may be a value between [0, 1] where 0 represents minimal dissimilarity and 1 represents maximum dissimilarity.

So, for common segment A, we may compare audio characteristics enclosed within common segment A:
(i) the second and first spectrograms 902, 901,
(ii) the second and third spectrograms, 902, 903, and
(iii) the first and second spectrograms, 901, 902, and compute the value of δ for each.

The process may be repeated for common segments B-F.

In terms of ordering, this comparison process may be performed, initially at least, for the first set of common segments 1002 using the second and first spectrograms 902, 901, and then repeated for the second set of common segments 1004 (which may comprise zero, or only a small number of new common segments) also taking into account the third spectrogram 903.

Alternatively, the process may be performed at the end of the segmentation process using the second set of common segments 1004.

Returning to FIG. 7, the segmentation module 704 may provide to the purifier module 706:
i) the first, second and third spectrograms, S₁-S₃, segmented using the common segments; and
ii) respective sets of dissimilarity values 41, 42, 43 for the first, second and third spectrograms S₁-S₃.

As mentioned above, each set 41, 42, 43 comprises values of {84, 8A . . . 8F} indicative of how similar or dissimilar audio characteristics within the common segments A-F are to the same common segments of the other spectrograms.

In accordance with the seventh operation 607, the purifier module 706 may be configured to select, for each common segment, which audio characteristics of the first, second and third spectrograms 901, 902, 903 within that common segment are to be used to generate the audio output.

In one example embodiment, the purifier module 706 may select, for each particular common segment, A-F, the audio characteristics most similar to those in the same segment of the other two spectrograms, i.e., that which has the lowest value of 8. Those selected audio characteristics can be merged (stitched together) across the respective common segments, A-F, to provide an output spectrogram S*.

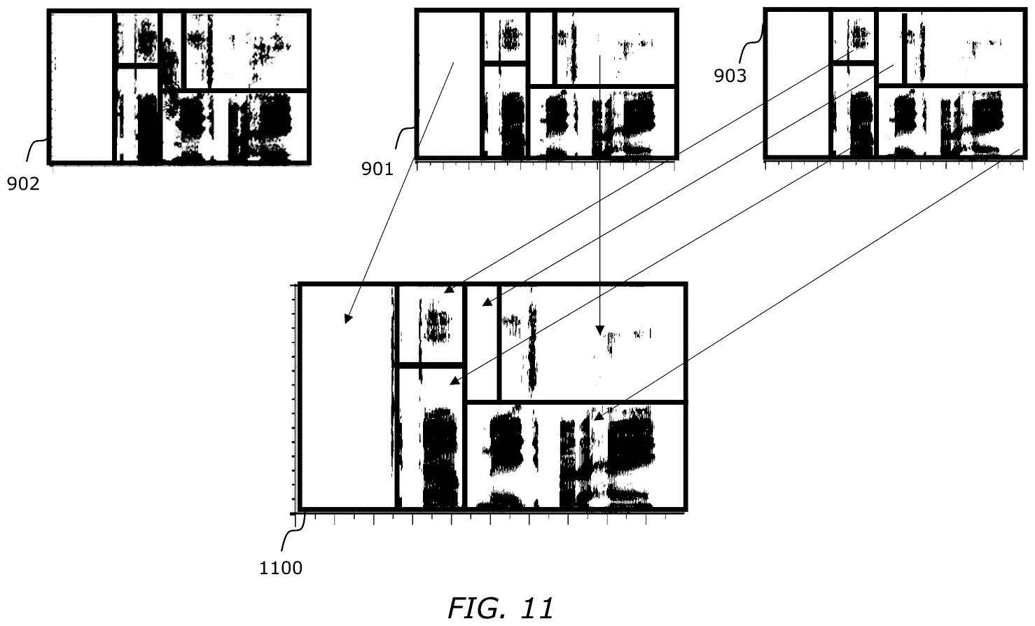

FIG. 11 illustrates the above concept. It will be seen that the second set of common segments 1004 is overlaid onto each of the first, second and third spectrograms 901, 902, 903.

Reference numeral 1100 is the output spectrogram S* comprising selected audio characteristics which come from either the first or the third spectrogram 901, 903. This is to be expected in this relatively simple example given that the second spectrogram 902 has the larger exposure value η.

The output spectrogram S* keeps the main characteristic (wanted audio) whilst removing or reducing the motion characteristics.

The output spectrogram S* may be provided by the purifier module 706 to the conversion module 708 which is configured to convert the output spectrogram S* to an output audio signal which is therefore denoised to some degree.

The “clean” output audio signal may then be provided to some further processing function, such as a speech recognition function and/or one or more ML processes.

In some example embodiments, rather than the above heuristic method, the purifier module 706 may implement one or more learned models, e.g., machine-learned (ML) models. The type of ML model or algorithm used may comprise a convolutional neural network (CNN). Although used largely for image processing, CNNs may be adapted for spectrogram generation. Convolutional layers of CNNs may capture local patterns, followed by pooling layers for downsampling. This may be effective for feature extraction from audio spectrograms and regenerating new audio spectrograms. For example, a CNN-based deep autoencoder may be trained to compress the input audio data into a lower-dimensional representation and then the spectrogram can be reconstructed from this representation. Similar techniques may be used with recurrent neural networks or transformers that are suitable for tasks where the temporal sequence of data is important, making them well-suited to embodiments described herein.

The one or more learned models may be configured to receive input data and to output the output spectrogram S* comprising the selected audio characteristics across the common segments. As in the previous example, the output spectrogram S* may be provided to the conversion module 708 which is configured to convert the output spectrogram S* to an output audio signal.

The one or more learned models may receive, as input:
the computed exposure parameters, η₁-η₃,
the respective spectrograms, and
the computed dissimilarity values, SA-8F, for the common segments of the respective spectrograms, S₁-S₃.

The one or more learned models may provide, as output, the output spectrogram S* which results from selecting for each common segment which audio characteristics in that common segment of the respective spectrograms are to be used to generate the audio output.

The one or more learned models may be trained using a particular type of wanted audio signal, e.g., speech or heartbeat. However, the type of audio data is not necessarily important. The one or more learned models may be trained using audio data generated in two settings, that is one when the mobile terminal is stationary and one when the mobile terminal is in motion.

For example, the one or more learned models may be trained by providing ground truth data corresponding to respective audio signals, A₁-A₃, received by the, or a same type of, mobile terminal when stationary. The same type of mobile terminal means a mobile terminal having the same number of microphones at substantially the same respective locations on the mobile terminal.

Reference exposure parameters, η₁-η₃, and dissimilarity values, SA-8F, for common segments of respective spectrograms may be generated for the respective audio signals, A₁-A₃, when the mobile terminal is in motion.

An initial model may provide output data representing selected audio characteristics for each common segment based on the computed reference exposure parameters, η₁-η₃, and dissimilarity values, SA-8F, for the common segments.

The output data may be compared with the ground truth data to determine error data, and the initial model may be updated based on the error data, e.g., using backpropagation and a suitable loss function to optimize the initial model, e.g. using gradient descent. The process may be repeated for multiple iterations or epochs of training data when the mobile terminal experiences different types of movement, prior to being implemented on the mobile terminal 100.

The learned model may, as noted above, comprise any suitable ML algorithm, for example an artificial neural network (ANN), such as a recurrent neural network (RNN).

In overview, example embodiments process respective spectrograms which may take into account how exposed different microphones are to pressure changes due to motion of the mobile terminal. Audio signals captured by the different microphones may be combined in a selective way via segmentation and quantifying audio characteristics similarity to produce an output spectrogram S* which denoises at least some audio characteristics due to the motion.

By segmenting respective spectrograms using common segments which may cover substantially all of the time and frequency space, time and frequency gaps can be avoided or mitigated against and hence any delays due to the respective positions of the microphones may not affect the result.

In some example embodiments, the exposure values η₁-η_{M}, generated by the kinematics module 702 may change a number of times within a particular time period as movement of the user terminal 100 changes. Example embodiments may therefore involve multiple iterations of segmenting spectrograms S₁-S₃ and purification by the purification module 706 within the particular time period. Synchronisation is therefore also handled efficiently.

### EXAMPLE APPARATUS

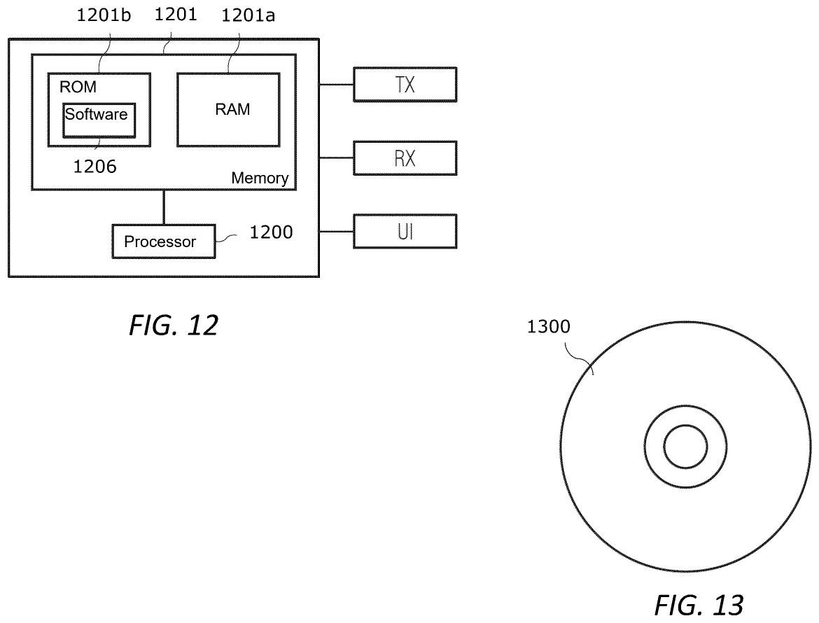

FIG. 12 shows an apparatus according to some example embodiments. The apparatus may be configured to perform the operations described herein, for example operations described with reference to any disclosed process. The apparatus comprises at least one processor 1200 and at least one memory 1201 directly or closely connected to the processor. The memory 1201 includes at least one random access memory (RAM) 1201a and at least one read-only memory (ROM) 1201b. Computer program code (software) 1206 is stored in the ROM 1201b. The apparatus may be connected to a transmitter (TX) and a receiver (RX). The apparatus may, optionally, be connected with a user interface (UI) for instructing the apparatus and/or for outputting data. The at least one processor 1200, with the at least one memory 1201 and the computer program code 1206 are arranged to cause the apparatus to at least perform at least the method according to any preceding process, for example as disclosed in relation to the flow diagram of FIG. 6 and related features thereof.

FIG. 13 shows a non-transitory media 1300 according to some embodiments. The non-transitory media 1300 is a computer readable storage medium. It may be e.g. a CD, a DVD, a USB stick, a blue ray disk, etc. The non-transitory media 1300 stores computer program instructions, causing an apparatus to perform the method of any preceding process for example as disclosed in relation to the flow diagram of FIG. 6 and related features thereof.

Names of network elements, protocols, and methods are based on current standards. In other versions or other technologies, the names of these network elements and/or protocols and/or methods may be different, as long as they provide a corresponding functionality. For example, embodiments may be deployed in 2G/3G/4G/5G networks and further generations of 3GPP but also in non-3GPP radio networks such as WiFi.

A memory may be volatile or non-volatile. It may be e.g. a RAM, a SRAM, a flash memory, a FPGA block ram, a DCD, a CD, a USB stick, and a blue ray disk.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Some embodiments may be implemented in the cloud.

It is to be understood that what is described above is what is presently considered the preferred embodiments. However, it should be noted that the description of the preferred embodiments is given by way of example only and that various modifications may be made without departing from the scope as defined by the appended claims.

1-27. (canceled)

28. An apparatus, comprising:
at least one processor; and
at least one memory storing instructions that, when executed by the at least one processor, cause the apparatus at least to perform:
receiving respective audio signals captured by a plurality of microphones, having different locations on a mobile terminal;
estimating motion of the mobile terminal when capturing the respective audio signals;
computing respective exposure parameters for the respective audio signals, the exposure parameter for a particular audio signal being based on the estimated motion of the mobile terminal and the location of the microphone from which the particular audio signal is captured;
generating respective spectrograms for the respective audio signals;
identifying a plurality of common time and frequency range segments across the respective spectrograms;
computing dissimilarity values for the common segments of the respective spectrograms based on, for audio characteristics within a particular segment of a particular spectrogram, how similar those audio characteristics are to audio characteristics within the same particular segment of the other spectrograms; and
based on the computed exposure parameters and the computed dissimilarity values, selecting, for each particular common segment, which of the audio characteristics within that particular common segment are to be used to generate an audio output.

29. The apparatus of claim 28, wherein:
identifying the plurality of common segments comprises:
determining an ordered list of the respective spectrograms, based on the respective exposure parameters computed for the respective audio signals from which the respective spectrograms are generated;
segmenting the first and second spectrograms in the ordered list to identify respective first and second sets of segments; and
combining the respective first and second sets of segments to identify a first plurality of common segments.

30. The apparatus of claim 29, wherein:
responsive to identifying the first plurality of common segments, computing the dissimilarity values comprises:
computing the dissimilarity values for the first plurality of common segments of the first and second spectrograms.

31. The apparatus of claim 29, wherein:
identifying the plurality of common segments further comprises for a next spectrogram in the ordered list:
segmenting the next spectrogram to identify a further set of segments; and
combining the further set of segments with the first plurality of common segments to identify an updated plurality of common segments.

32. The apparatus of claim 30, wherein:
responsive to identifying the updated plurality of common segments, computing the dissimilarity values comprises:
computing the dissimilarity values for the updated plurality of common segments of the first, second and next spectrograms.

33. The apparatus of claim 29, wherein:
the respective exposure parameters are indicative of the exposure to airflow of the respective microphones from which the respective audio signals are captured due to the motion of the user terminal, and
the ordered list is in the order of the most exposed microphone to the least exposed microphone.

34. The apparatus of claim 28, wherein:
the selecting comprises use of a learned model for:
receiving as a set of input data:
the computed exposure parameters for the respective audio signals,
the respective spectrograms, and
the computed dissimilarity values for the common segments of the respective spectrograms:
selecting, for each common segment, and based on the set of input data, which audio characteristics in that common segment of the respective spectrograms are to be used to generate the audio output; and
providing as output data the selected audio characteristics for the common segments.

35. The apparatus of claim 34, wherein:
the learned model is trained by:
providing ground truth data corresponding to respective audio signals received by the plurality of microphones, when a same type of mobile terminal is stationary;
computing reference exposure parameters and dissimilarity values for common segments of respective spectrograms generated when said same type of mobile terminal is in motion;
using an initial model to provide output data representing selected audio characteristics for each common segment based on the reference exposure parameters and dissimilarity values;
comparing the output data with the ground truth data to determine error data; and updating the initial model based on the error data.

36. The apparatus of claim 28, wherein:
the selected audio characteristics for each common segment are provided in an output spectrogram, and
the apparatus is further caused to convert the output spectrogram to an audio output.

37. The apparatus of claim 28, wherein:
estimating motion of the mobile terminal comprises receiving one or more motion parameters indicative of at least a direction of motion of the mobile terminal, and the exposure parameter for the particular audio signal is computed based on the location of the microphone, from which the particular audio signal is captured in relation to the direction of the motion.

38. The apparatus of claim 37, wherein:
estimating motion of the mobile terminal is configured to receive further motion parameters indicative of a velocity of the motion and an orientation of the mobile terminal, and
the exposure parameter, for the particular audio signal, is computed further based on the velocity of the motion and the orientation of the mobile terminal.

39. The apparatus of claim 37, wherein the one or more motion parameters are received from an inertial measurement unit, IMU, of the mobile terminal.

40. The apparatus of claim 28, wherein:
the respective audio signals are captured within a particular time window;
the respective exposure parameters and dissimilarity values for the common segments of the respective spectrograms, are updated a plurality of times within the particular time window; and
the computed audio output is updated within the particular time window based on the updated respective exposure parameters and dissimilarity values.

41. A method, comprising:
receiving respective audio signals captured by a plurality of microphones, having different locations on a mobile terminal;
estimating motion of the mobile terminal when capturing the respective audio signals;
computing respective exposure parameters, for the respective audio signals, the exposure parameter for a particular audio signal being based on the estimated motion of the mobile terminal and the location of the microphone from which the particular audio signal is captured;
generating respective spectrograms for the respective audio signals;
identifying a plurality of common time and frequency range segments across the respective spectrograms;
computing dissimilarity values for the common segments of the respective spectrograms based on, for audio characteristics within a particular segment of a particular spectrogram, how similar those audio characteristics are to audio characteristics within the same particular segment of the other spectrograms; and
based on the computed exposure parameters and the computed dissimilarity values, selecting, for each particular common segment, which of the audio characteristics within that particular common segment are to be used to generate an audio output.

42. The method of claim 41, wherein:
identifying the plurality of common segments comprises:
determining an ordered list of the respective spectrograms, based on the respective exposure parameters computed for the respective audio signals from which the respective spectrograms are generated;
segmenting the first and second spectrograms in the ordered list to identify respective first and second sets of segments; and
combining the respective first and second sets of segments to identify a first plurality of common segments.

43. The method of claim 41, wherein:
computing the dissimilarity values comprises, responsive to identifying the first plurality of common segments:
computing the dissimilarity values, for the first plurality of common segments of the first and second spectrograms.

44. The method of claim 42, wherein:
identifying the plurality of common segments further comprises for a next spectrogram in the ordered list:
segmenting the next spectrogram to identify a further set of segments; and
combining the further set of segments with the first plurality of common segments to identify an updated plurality of common segments.

45. The method of claim 44, wherein:
computing the dissimilarity values, comprises, responsive to identifying the updated plurality of common segments:
computing the dissimilarity values, for the updated plurality of common segments of the first, second and next spectrograms.

46. The method of claim 41, wherein:
the selecting comprises use of a learned model for:
receiving as a set of input data:
the computed exposure parameters for the respective audio signals,
the respective spectrograms, and
the computed dissimilarity values, for the common segments of the respective spectrograms;
selecting, for each common segment, and based on the set of input data, which audio characteristics in that common segment of the respective spectrograms are to be used to generate the audio output; and
providing as output data the selected audio characteristics for the common segments.

47. A non-transitory computer readable medium comprising program instructions stored thereon to cause the apparatus to carry out a method, comprising:
receiving respective audio signals captured by a plurality of microphones, having different locations on a mobile terminal;
estimating motion of the mobile terminal when capturing the respective audio signals;
computing respective exposure parameters for the respective audio signals, the exposure parameter for a particular audio signal being based on the estimated motion of the mobile terminal and the location of the microphone from which the particular audio signal is captured;
generating respective spectrograms for the respective audio signals;
identifying a plurality of common time and frequency range segments across the respective spectrograms;
computing dissimilarity values for the common segments of the respective spectrograms based on, for audio characteristics within a particular segment of a particular spectrogram, how similar those audio characteristics are to audio characteristics within the same particular segment of the other spectrograms; and
based on the computed exposure parameters and the computed dissimilarity values, selecting, for each particular common segment, which of the audio characteristics within that particular common segment are to be used to generate an audio output.
